(19) United States
(12) Patent Application Publication
(10) Pub. No.: US 2019/0042037 A1
(43) Pub. Date: Feb. 7, 2019

(54) TWIN-MODE TOUCH DISPLAY PANEL

(71) Applicant: HON HAI PRECISION INDUSTRY CO., LTD., New Taipei (TW)

(72) Inventors: CHIA-LIN LIU, New Taipei (TW); YU-FU WENG, New Taipei (TW); CHIEN-WEN LIN, New Taipei (TW); TZU-YU CHENG, New Taipei (TW)

(21) Appl. No.: 15/988,014

(22) Filed: May 24, 2018

(30) Foreign Application Priority Data
Aug. 4, 2017 (CN) 201710662812.6

(51) Int. Cl. G06F 3/041; G06F 3/044; G02F 1/1333; G09G 3/36; G02F 1/1343

(52) U.S. Cl. CPC G06F 3/0412; G06F 3/044; G02F 1/13338; G02F 2201/123; G02F 1/134309; G02F 2201/121; G09G 3/36

(57) ABSTRACT

A touch display panel operating in alternating touch-sensing modes includes a first substrate and a second substrate facing the first substrate, and with first electrodes on the first substrate and second electrodes on the second substrate. The touch display panel can work in a self-capacitance mode and a mutual-capacitance mode in sensing touch operations. The mutual-capacitance mode is implemented by the first electrodes and the second electrodes working together and the self-capacitance mode is implemented by the first electrodes alone.

### FIELD

The subject matter herein generally relates to a touch display panel.

### BACKGROUND

An on-cell or in-cell type touch screen panel can be manufactured by installing a touch panel in a display panel. Such a touch screen panel is used as a display device while being used as an input device for receiving a user's touch command on a specific area. However, such a touch screen panel cannot sense the intensity of the touch force.

### BRIEF DESCRIPTION OF THE DRAWINGS

Implementations of the present disclosure will now be described, by way of example only, with reference to the attached figures.

FIG. 1 is a planar view of an exemplary embodiment of a touch display panel.

FIG. 2 is a cross-sectional view along line II-II of FIG. 1.

FIG. 3 is a planar view showing a layout of first electrodes of a touch display panel.

FIG. 4 is a planar view showing a layout of second electrodes of a touch display pane according to a first embodiment of the present disclosure.

FIG. 5 is a planar view showing a layout of second electrodes of a touch display pane according to a second embodiment of the present disclosure.

FIG. 6 is a driving method of a touch display device in a mutual-capacitance mode.

FIG. 7 is a first driving method of a touch display device in a self-capacitance mode.

FIG. 8 is a second driving method of a touch display device in a self-capacitance mode.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series, and the like.

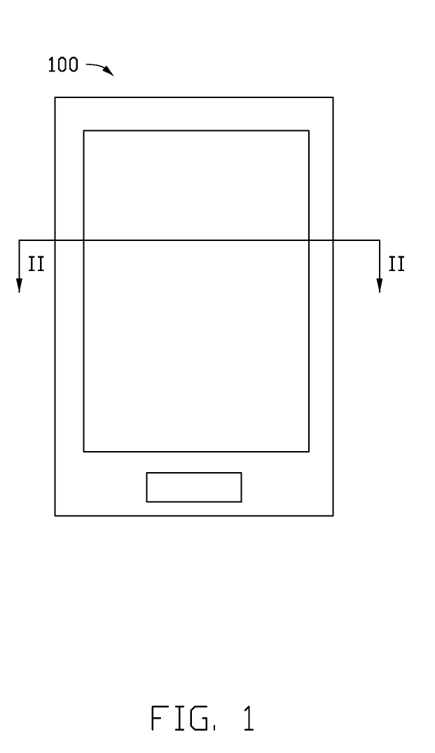

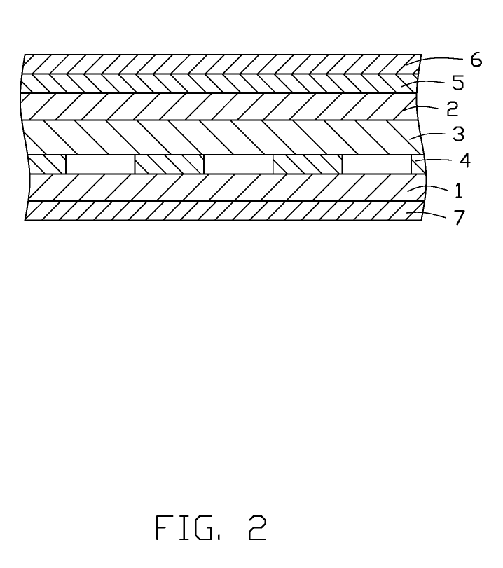

FIG. 1 and FIG. 2 illustrate a touch display panel 100 according to an exemplary embodiment. The touch display panel 100 is a liquid crystal touch display panel and includes a first substrate 1, a second substrate 2 facing and spaced apart from the first substrate 1, and a liquid crystal layer 3 between the first substrate 1 and the second substrate 2. A plurality of first electrodes 4 is located on a side of the first substrate 1 adjacent to the liquid crystal layer 3. The first electrodes 4 are spaced apart from each other. A plurality of second electrodes 5 is located on a side of the second substrate 2 away from the liquid crystal layer 3. The second electrodes 5 are spaced apart from each other. The touch display panel 1 further includes an upper polarizer 6 located on a side of the second electrodes 5 away from the second substrate 2 and a bottom polarizer 7 located on a side of the first substrate 1 away from the second substrate 2.

In the present embodiment, the first substrate 1 is a thin film transistor (TFT) array substrate and includes a base substrate (not shown) and a plurality of TFTs (not shown) formed on the base substrate. The first electrodes 4 function as common electrodes of the touch display panel 100, and cooperate with pixel electrodes (not shown) of the touch display panel 100 to realize a display. In particular, the first electrodes 4 cooperate with pixel electrodes (not shown) to form an electrical field to rotate the liquid crystal molecules of the liquid crystal layer 3. The first electrodes 4 can also function as touch electrodes for sensing touch position.

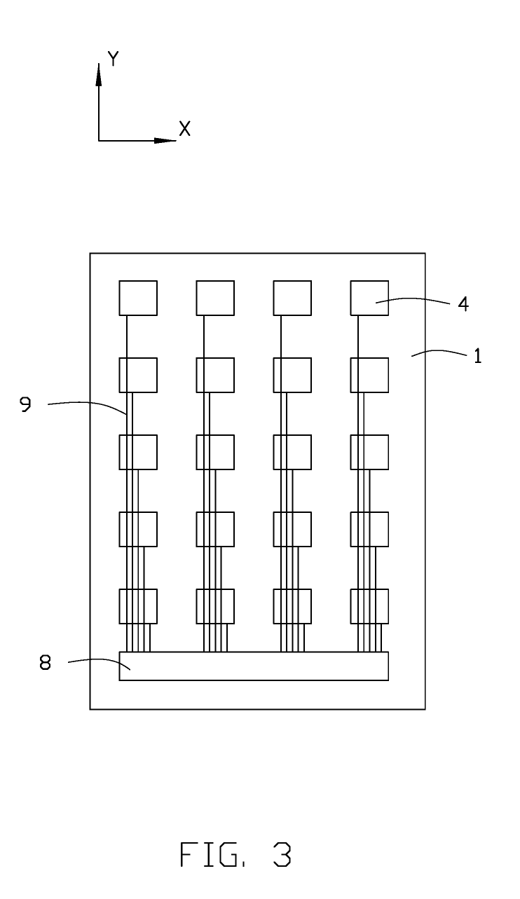

FIG. 3 illustrates a layout of the first electrodes 4. The first electrodes 4 are arranged in an array having a plurality of rows extending in a first direction (X direction of FIG. 3) and a plurality of columns extending in a second direction (Y direction of FIG. 3). In the present embodiment, each first electrode 4 has a substantially rectangular shape. Each first electrode 4 may have a length of about 3 mm to about 6 mm and a width of about 3 mm to about 6 mm. In other embodiments, each first electrode 4 may have other shape, such as rhomboid, round, and the like. As shown in FIG. 3, the touch display panel 100 further includes a driving circuit 8, and each first electrode 4 is electrically coupled to the driving circuit 8 by a first conductive line 9. In the present embodiment, the driving circuit 8 is an integrated circuit combining the touch driver and display driver. In other embodiments, there may be two driving circuits independent from each other. One of the two driving circuits is a display driving circuit and the other one of the two driving circuits is a touch driving circuit.

The first electrodes 4 allow light to pass through. The first electrodes 4 may be made of a conventional transparent conductive material, such as indium tin oxide (ITO). Alternatively, the first electrodes 4 may consist of metal meshes.

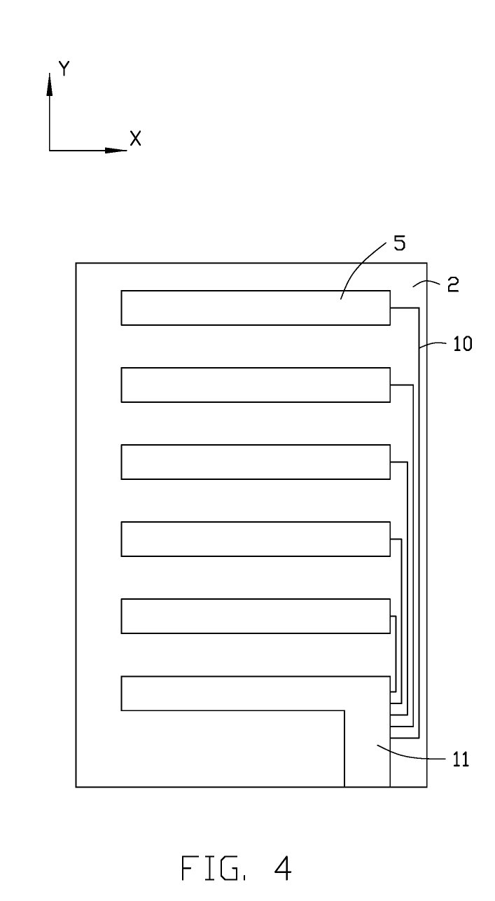

In the present embodiment, the second substrate 2 is a color filter substrate. FIG. 4 illustrates a layout of the second electrodes 5. The second electrodes 5 are located on the second substrate 2 and spaced apart from each other. Each second electrode 5 extends as a strip along the first direction, and all of the second electrodes 5 are arranged in one column along the second direction. Each second electrode 5 corresponds to one row of the first electrodes 4. Each second electrode 5 is electrically coupled to a flexible printed circuit board 11 by a second conductive line 10. The flexible printed circuit board 11 (not shown) is electrically coupled to the driving circuit 8, although not shown in figures.

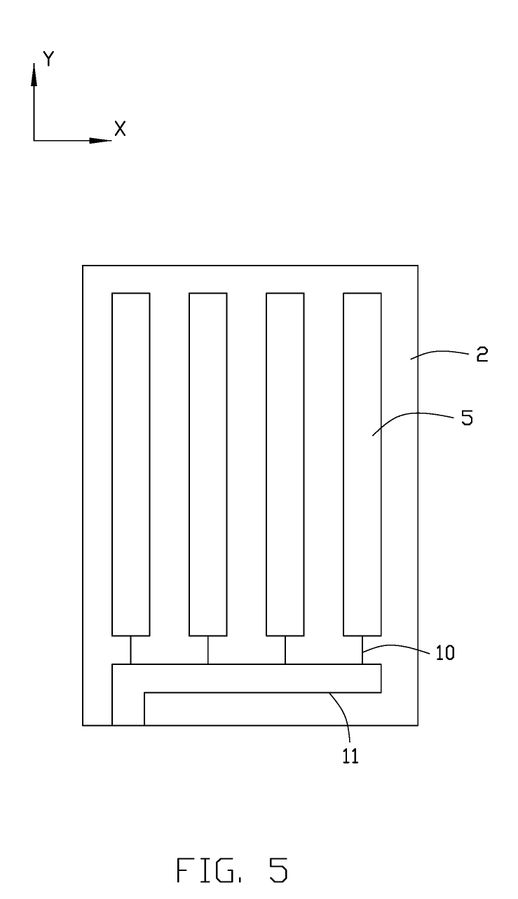

In other embodiments, the second electrodes 5 can have other layouts. For example, as shown in FIG. 5, each second electrode 5 extends as a strip along the second direction, and all of the second electrodes 5 are arranged in one row along the first direction. Each second electrode 5 corresponds to one column of the first electrodes 4.

The second electrodes 5 allow light to pass through. The second electrodes 5 may be made of a conventional transparent conductive material, such as indium tin oxide (ITO). Alternatively, the second electrodes 5 may consist of metal meshes.

The touch display device 100 has two touch sensing modes, a self-capacitance mode and a mutual-capacitance mode. The touch display device 100 can function in the self-capacitance mode or the mutual-capacitance mode.

When the touch display device 100 is working in the self-capacitance mode, a self-capacitance touch sensing is implemented by the first electrodes 4. Specifically, a touch driving signal transmitted from the driving circuit 8 is applied to each first electrode 4. At this time, no electrical signal is applied to the second electrode 5 and the second electrode 5 is floating. When a finger touches the touch display device 100, the electrical signals of the first electrodes 4 in the touch area may change, thus the touch position of the fingertip may be calculated according to variation of the electrical signals of the first electrodes 4.

When the touch display device 100 is working in the mutual-capacitance mode, a mutual-capacitance touch sensing is implemented by the first electrodes 4 and the second electrodes 5. A touch driving signal transmitted from the driving circuit 8 is applied to each first electrode 4. The second electrodes 5 generate touch sensing signals and these signals from the second electrodes 5 are transmitted to the driving circuit 8 by the flexible printed circuit board 11. When a fingertip touches the touch display device 100, a capacitance between the first electrodes 4 and the second electrodes 5 in the touch area changes, thus the touch position of the fingertip may be calculated according to variation of the capacitance.

The touch display device 100 is capable of switching itself between the self-capacitance touch sensing mode and the mutual-capacitance touch sensing mode. The driving circuit 8 may control switching of the touch display device 100 between the two modes. The driving circuit 8 includes a plurality of analog-to-digital converters (not shown) configured for processing signals. At a same touch frequency, the number of the analog-to-digital converters used in the mutual-capacitance mode is less than the number of the analog-to-digital converters used in the self-capacitance mode, thus less power is consumed. The electrical field generated in the self-capacitance mode is strong, and the capacitance variation in the self-capacitance mode is greater than the capacitance variation in the mutual-capacitance mode. The variation in capacitance decreases as the distance between the fingertip and the touch display device 100 increases. Therefore, detection of a floating touch can be realized in the self-capacitance mode; floating touch sensing can include an air gap (not shown) between the finger and the touch display device 100.

Therefore, when the frequency of touch on the touch display device 100 is low (e. g, the touch display device 100 is perhaps being viewed only and not subject to heavy user input), the touch display device 100 may be switched to the self-capacitance mode, so as to achieve the functions of touch sensing and floating touch sensing. At this time, the portion of the driving circuit 8 related to the mutual-capacitance mode is in a sleep state. When the frequency of touch on the touch display device 100 is high, the touch display device 100 may be switched to the mutual-capacitance mode. At this time, the portion of the driving circuit 8 related to the self-capacitance mode is in a sleep state.

The displaying driving and touch sensing driving of the touch display panel 100 can be carried out in a time division method. The first electrodes 4 can function as common electrodes and receive display driving signals but can also function as touch sensing electrodes and receive touch sensing driving signals.

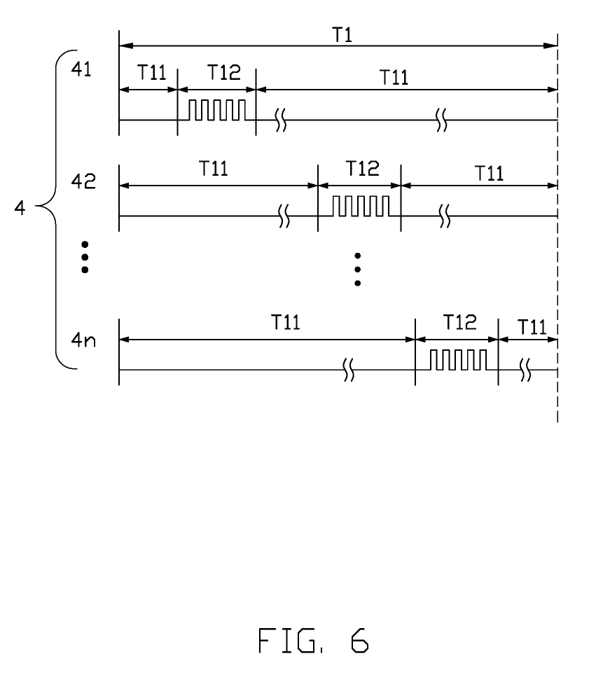

FIG. 6 shows electrical signals applied to the first electrodes 4 when the touch display device 100 is in a mutual-capacitance mode. As shown in FIG. 6, the plurality of first electrodes 4 are labeled 41, 42, . . . 4n. The touch display device 100 is driven in a plurality of frames. One frame time is a time period for loading one display image. For example, one frame time may equal 16.667 ms. As shown in FIG. 6, for each first electrode 4, one frame time T1 is divided into two display periods T11 and a touch period T12, the touch period T12 being between the two display periods T11. The driving circuit 8 drives the touch display panel 100 to display during the display period T11, to detect touch operations during the touch period T12, and to again display during the display period T11, all within a single frame. During the display period T11, a common voltage (a direct current voltage) is applied to the first electrode 4. During the touch period T12, a touch sensing driving signal (alternating current voltage) is applied to the first electrode 4. During each frame time T1, the touch periods T12 of each first electrode 4 never overlap.

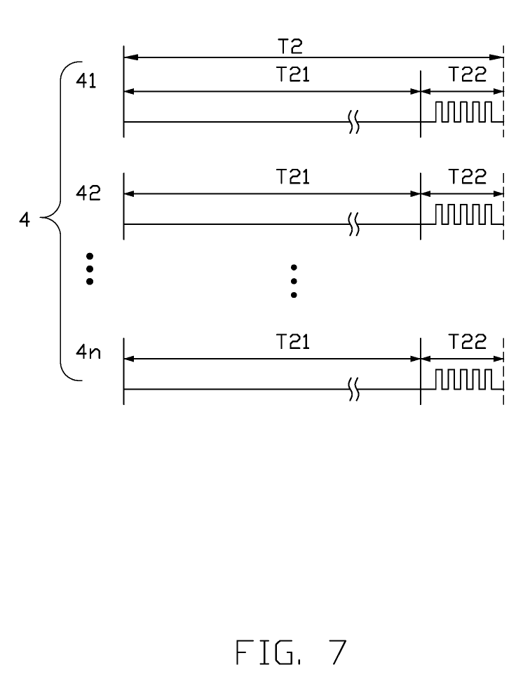

FIG. 7 shows electrical signals applied to the first electrodes 4 when the touch display device 100 is in a self-capacitance mode. As shown in FIG. 7, the plurality of first electrodes 4 are labeled 41, 42, . . . 4n. The touch display device 100 is driven in frames. One frame time is a time period for loading one display image. For example, one frame time may equal 16.667 ms. As shown in FIG. 7, for each first electrode 4, each frame time T2 is divided into a display period T21 and a touch period T22. The driving circuit 8 drives the touch display panel 100 to display during the display period T21 and to detect touch operations during the touch period T22 in each single frame. During the display period T21, a common voltage (a direct current voltage) is applied to the first electrode 4. During the touch period T22, a touch sensing driving signal (alternating current voltage) is applied to the first electrode 4. During one frame time T1, the touch period T12 of each first electrode 4 overlap with each other.

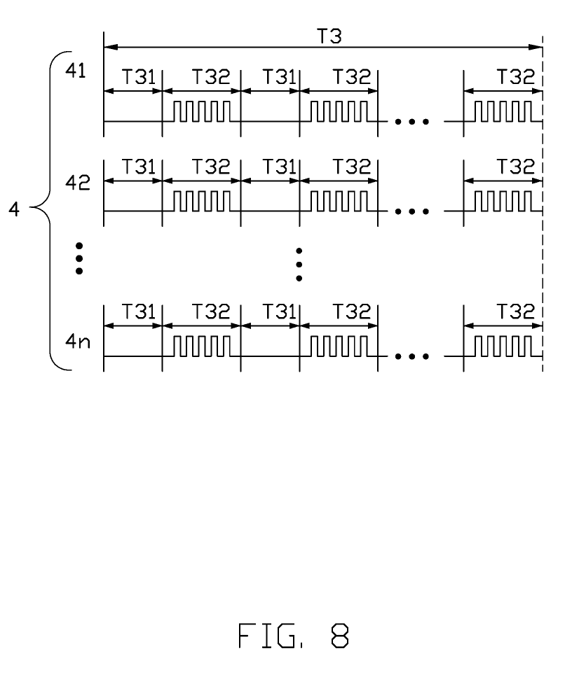

FIG. 8 shows electrical signals applied to the first electrodes 4 when the touch display device 100 is in a self-capacitance mode. As shown in FIG. 8, the first electrodes 4 are labeled 41, 42, . . . 4n. The touch display device 100 is driven in frames. One frame time is a duration time for loading one display image. For example, one frame time may equal to 16.667 ms. As shown in FIG. 8, for each first electrode 4, each frame time T3 is divided into display periods T31 and touch periods T32. The driving circuit 8 alternately drives the touch display panel 100 to display during a display period T31 and to detect touch operations during a touch period T32 in a single frame. During the display period T21, a common voltage (a direct current voltage) is applied to the first electrode 4. During the touch period T22, a touch sensing driving signal (alternating current voltage) is applied to the first electrode 4. During one frame time T1, the touch periods T12 of each first electrode 4 overlap with each other.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A touch display panel, comprising:
a first substrate;
a second substrate facing the first substrate;
a plurality of first electrodes on the first substrate, the plurality of first electrodes being spaced apart from each other; and
a plurality of second electrodes on the second substrate, the plurality of second electrodes being spaced apart from each other;
wherein the touch display panel is capable of working in a self-capacitance mode and a mutual-capacitance mode both for sensing touch operation, by switching between the self-capacitance mode and the mutual-capacitance mode; the self-capacitance mode is implemented by the plurality of first electrodes; the mutual-capacitance mode is implemented by the plurality of first electrodes and the plurality of second electrodes.

2. The touch display device of claim 1, wherein the first substrate is a thin film transistor array substrate; the second substrate is a color filter substrate; and a liquid crystal layer is between the first substrate and the second substrate.

3. The touch display device of claim 2, wherein the plurality of first electrodes is located on a side of the first substrate adjacent to the liquid crystal layer.

4. The touch display device of claim 2, wherein the plurality of second electrodes is located on a side of the second substrate away from the liquid crystal layer.

5. The touch display device of claim 1, wherein the plurality of first electrodes are arranged in an array.

6. The touch display device of claim 1, wherein each of the plurality of second electrodes extends as a strip; and the plurality of second electrodes are parallel to each other.

7. The touch display device of claim 1, wherein the plurality of first electrodes also function as common electrodes for display.

8. The touch display device of claim 7, further comprising a driving circuit electrically coupled to the plurality of first electrodes and the plurality of second electrodes.

9. The touch display device of claim 8, wherein the touch display panel are driven in a time division method; the touch display device is driven in a plurality of frames; each frame time is divided into at least one display period and at least one touch period; the driving circuit drives the touch display panel to display during the display period to detect touch operation during the touch period; during each of the at least one display period, a common voltage is applied to the first electrode; during each of the at least one touch period, a touch sensing driving signal is applied to the first electrode.

10. The touch display device of claim 9, wherein when the touch display device is in a mutual-capacitance mode, the at least one touch period of each of the plurality of first electrodes does not overlap with each other during each frame time.
